(19) United States
(12) Patent Application Publication
(10) Pub. No.: US 2002/0159596 A1
(43) Pub. Date: Oct. 31, 2002

(54) Rendering of content

(76) Inventors: Julian Durand, Cambridge, MA (US); Tommy Arnberg, Espoo (FI); Piotr Cofta, Helsinki (FI); Kimmo Djupsjobacka, Tampere (FI); Pekka Koponen, Espoo (FI); Pasi Toiva, Tampere (FI); Jari Vaario, Beijing (CN); Jukka Parkkinen, Oulu (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/134,370

(22) Filed: Apr. 30, 2002

Related U.S. Application Data
(60) Provisional application No. 60/287,017, filed on Apr. 30, 2001.

(51) Int. Cl. H04K 1/00

(52) U.S. Cl. 380/255

(57) ABSTRACT

A personal trusted device is capable of communicating with a rendering machine such as an audio amplifier. Content to be played on the amplifier is selected by a user of the personal trusted device, the relevant permissions being negotiated between the device and the machine. Thus, it is possible for encrypted digital content to be rendered at a location and on a machine suited to the user's requirements.

### CROSS REFERENCE TO RELATED APPLICATION

The present application claims the benefit of priority of U.S. Provisional Application Serial No. 60/287,017, filed Apr. 30, 2001 the contents of which are incorporated herein by reference.

### BACKGROUND OF THE INVENTION

The present invention relates to the rendering of content, particularly although not exclusively content having digital rights such as copyright therein.

Typically, content such as video, audio or textual data is consumed by a user via a rendering device. A rendering device transforms the data defining the content into a form which may be interpreted by a user's senses. Thus, content in the form of video may be rendered on a visual display unit or monitor, audio content may be rendered by a stereo system and a printer used to render textual content, to name but a few examples. In many cases, such as the distribution of content recorded on magnetic media, optical disk or the like, a number of stages will take place in rendering the data to a form suitable for interpretation by a user's senses.

With the advent of digital content distribution, the opportunity has arisen for faultless replication of content to be carried out. Clearly, without appropriate controls, such replication or copying can take place without the agreement of a relevant right holder. A particular challenge to the content generating community, which includes record companies, publishers and other right holders, is the ease with which digital content may be disseminated, particularly over networks. This ease of dissemination is also coupled with the fact that there is little or no degradation in the quality of the content despite repeat copying and forwarding of the content in its original format. Thus, unauthorized copies of copyright context will meet the same high expectations of consumers in relation to the authorized content.

Consequently, many approaches have been implemented and are being developed to protecting such content. Such approaches broadly constitute, on the one hand, the creation of technical barriers to unauthorized copying of content and on the other hand, the development of transactional controls. In many cases, both approaches have been used in tandem to attempt to strictly control the distribution of content to authorized recipients such as those users who have paid the appropriate fee to the right holder, for example. Thus, rendering devices or players have been developed which incorporate the technical features necessary to protect content delivered thereto.

### SUMMARY OF THE INVENTION

According to one aspect of the invention, there is provided a method of rendering content on a rendering machine connectable to a personal trusted device, the method comprising the personal trusted device sending a request identifying encrypted content to be rendered to said rendering machine and responding to a request from said rendering machine by delivering a content decryption key corresponding to the encrypted content obtained thereby.

Previously users were able to purchase physical media such as compact discs, and cassette tapes which could be inserted for playback into personal, possibly portable, rendering devices or players. Users were not typically limited as to the choice of player through which they could enjoy their content. Provided the player was compatible with the format of the particular media carrying the content, any player could be used. However, although devices are known which permit a user to download, store and subsequently render protected digital content such devices, through the very protection mechanisms deployed in relation to the content, effectively restrict the user to enjoying the content through the particular device to which the content has been downloaded.

Thus, according to another aspect of the present invention, there is provided a personal trusted device for connection to a rendering machine, the device including a user interface for selecting encrypted content to be rendered, a communications terminal operable to establish a channel with a rendering machine over which a request identifying said encrypted content may be delivered, and a protected processing environment operable to provide a content decryption key corresponding to content selected by said user interface, said key being deliverable over said channel to facilitate decryption of said content obtained by said rendering machine.

By removing the linkage between content and player, the present invention provides all the advantages conferred by the distribution of content on physical media whilst maintaining the protection of that content necessary to preserve the rights of the owner.

As a consequence of this separation of the rendering device from the protected processing environment of the personal trusted device (PTD) a user is free to render content on any suitable rendering machine provided she holds the requisite permissions conveniently provided in a voucher held possibly within the PTD or on a remote mediary. Examples of rendering machines include televisions, audio amplifiers, video recorders and the like.

Thus, according to a further aspect of the invention, there is provided a personal trusted device for connection to a rendering machine, the device including a user interface for selecting encrypted content to be rendered, a communications terminal operable to establish a channel with a rendering machine over which a request identifying said encrypted content may be delivered, and a protected processing environment operable to provide a content decryption key corresponding to content selected by said user interface, said key being deliverable over said channel to facilitate decryption of said content obtained by said rendering machine.

Whether the voucher is stored locally or remotely may conveniently be decided on the basis of frequency of access or indeed any other policy including a policy set by the right holder.

With respect to the content, this may be stored in encrypted form on media directly accessible to the rendering device such as a local storage device having first been downloaded from a server, or possibly read from a compact disc or other form of physical media. Alternatively, the encrypted content could be streamed to the rendering device in near real or real time. It will be apparent to those skilled in the art that whatever the route taken for delivery of content to the rendering device, that content must remain encrypted unless and until the necessary permissions for decrypting the content have been obtained by the rendering device.

Thus, according to another aspect of the present invention, there is provided a method of rendering content on a rendering machine connectable to a personal trusted device, the method comprising the rendering machine receiving a request from a personal trusted device connected thereto said request identifying encrypted content to be rendered, obtaining said encrypted content from a repository and acquiring a content decryption key from said personal trusted device, said key being used to decrypt said content.

The channel utilized to deliver the encrypted content need not be secure and could be set up using a dial-up connection over a telephone line to the ISP with the ISP providing access to the storage on the Internet. Alternatively the connection could be permanent over a Digital Subscriber Loop (DSL) which could be symmetric, asymmetric or otherwise. Where the rendering machine is permanently connected to a network such as the Internet then it is provided with its own IP address.

### BRIEF DESCRIPTION OF THE DRAWINGS

In order to understand the present invention more fully, a number of embodiments thereof will now be described by way of example and with reference to the accompanying drawings, in which:

FIG. 1 is a block diagram illustrating a rendering system in accordance with one aspect of the invention;

FIG. 2 is a schematic diagram of a Personal Trusted Device of the system in accordance with FIG. 1;

FIG. 3 is a schematic diagram of a rendering machine of the system in accordance with FIG. 1;

FIG. 4 is a voucher for use in the system of FIG. 1;

FIG. 5 is a scrap diagrammatic view of a security element forming part of the Personal Trusted Device of FIG. 1;

FIG. 6 is a schematic view illustrating an architecture of the system of FIG. 1;

FIG. 7 is a schematic view illustrating a further architecture of the system of FIG. 1;

FIG. 8 is a schematic view illustrating a still further architecture of the system of FIG. 1;

FIG. 9 is a schematic view illustrating a yet further architecture of the system of FIG. 1; and

FIG. 10 is a schematic view illustrating another architecture of the system of FIG. 1.

FIG. 11 is a view similar to that of FIG. 6 with some details omitted for clarity;

FIG. 12 is a schematic view of a content server of the system of FIG. 1; and

FIG. 13 is a schematic view of a content request in accordance with the system of FIG. 1.

### DETAILED DESCRIPTION OF THE INVENTION

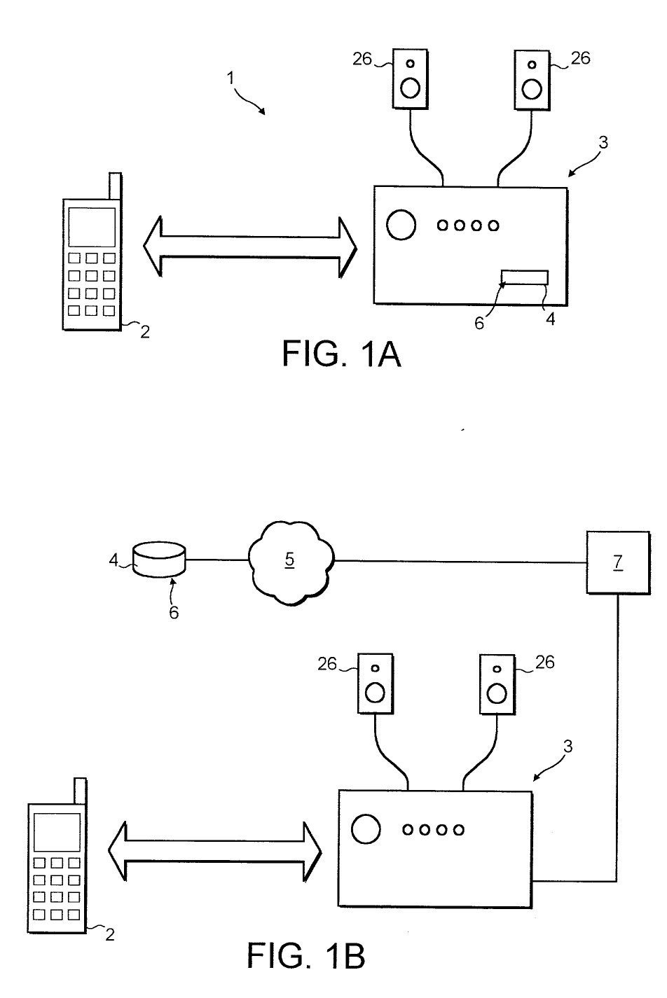

Referring to FIG. 1a, there is shown a rendering system 1 including a personal trusted device (PTD) 2 and a rendering machine 3 having content storage 4 in the form of a physical data carrier such as a memory card or hard disk 6. Utilizing the same reference numerals where appropriate, FIG. 1b illustrates a variant of the system of FIG. 1a in which the secure storage 4 is provided by a repository 6 connected to a network 5 to which the rendering machine 3 has access via an Internet Service Provider (ISP) 7. Indeed, the ISP 7 may be responsible for hosting the repository 6.

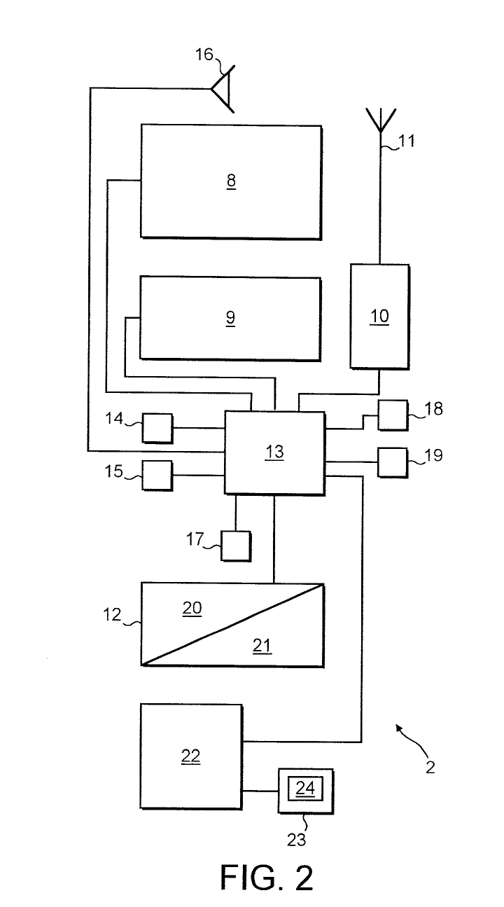

FIG. 2 shows in more detail that the PTD 2 includes a display 8, a data entry device such as a keypad 9, a transceiver 10 and antenna 11, a general memory 12 and a controller 13. In addition, the PTD 2 is provided with audio/video outputs 14 as well as a headphone jack 15, a speaker 16 and a microphone 17. The PTD 2 provides all the well-known functions of a mobile station connectable to a cellular network, thus a user may place and receive voice calls and generate and receive text messages. Furthermore, the PTD 2 provides facilities for browsing a network such as the Internet and provision for direct connection to other devices using a wireless interface 18 such as Infrared or Low Power Radio Frequency (LPRF) or a fixed cable connection 19 such as USB, IEEE1394. All of these features are made available to a user via a User Interface (UI) which provides the user with access to the features of the PTD 2 controlled by the controller 13. Further details of this and other interfaces utilized by the PTD are set out below. The general memory 12, which includes Read Only and Random Access portions (ROM, RAM) 20,21, provides storage for the code necessary to implement the PTD 2 functions and also storage for data which has been generated, received or otherwise utilized by the PTD 2 except to the extent that the function is carried out by or relates to a Protected Processing Environment (PPE) 22.

The PPE 22 of the PTD 2 implements the functionality required to enable Digital Rights Management (DRM) of content received or manipulated by the PTD 2. In addition to the connection to the controller 13, the PPE 22 is connected to a Security Element Interface 23 providing a secure access channel to a tamper resistant storage module, hereinafter referred to as a Security Element (SE) 24. The SE 24 holds private keys, certificates and other personal data belonging to a user. The SE 24 inhibits access to the data stored therein by a combination of physical and software barriers the principles of which will be well known to those skilled in the art.

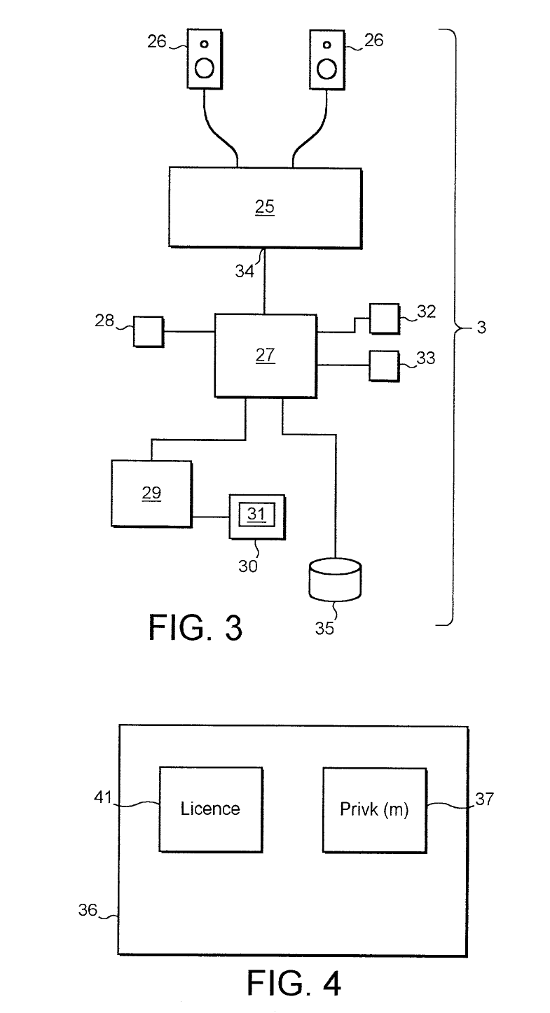

Turning now to FIG. 3, the rendering machine 3, in this case an audio amplifier 25 connected to a pair of speakers 26, includes a controller 27 providing a number of interfaces. A first network interface 28 provides for connection to a network capable of delivering encrypted content to the rendering machine 3. The rendering machine 3 further incorporates its own Protected Processing Environment (PPE) 29 which is connected to a Security Element (SE) 31 via a security element interface 30. The SE 31 holds at least a rendering machine private key PrivK(re). The rendering machine PPE 29 is required in order to authenticate a request from a PTD 2 to render content on the rendering machine 3. A set of PTD interfaces 32,33 allow a direct connection to be made between the rendering machine 3 and the PTD 2. The interfaces 32,33 respectively permit wired and wireless connections to be established with the PTD 2 using appropriate technologies such as Infrared, Lower Power Radio Frequency and cabled connections such as IEEE 1394, USB or the like. A connection is also provided between the controller 27 and an input stage 34 of the amplifier 25. The controller 27 is responsible for the operation of the above described interfaces and connections to enable rendering of authorized content by the amplifier 25. The storage device 35 provides temporary storage for content to be rendered by the rendering machine 3.

Whether the content is found on a data carrier such as a compact disc or memory card or on a hard disk of a repository, it is encrypted utilizing a public key associated with that content. The public key, hereinafter the media public key PubK(m), is generated as part of a key pair by the content owner.

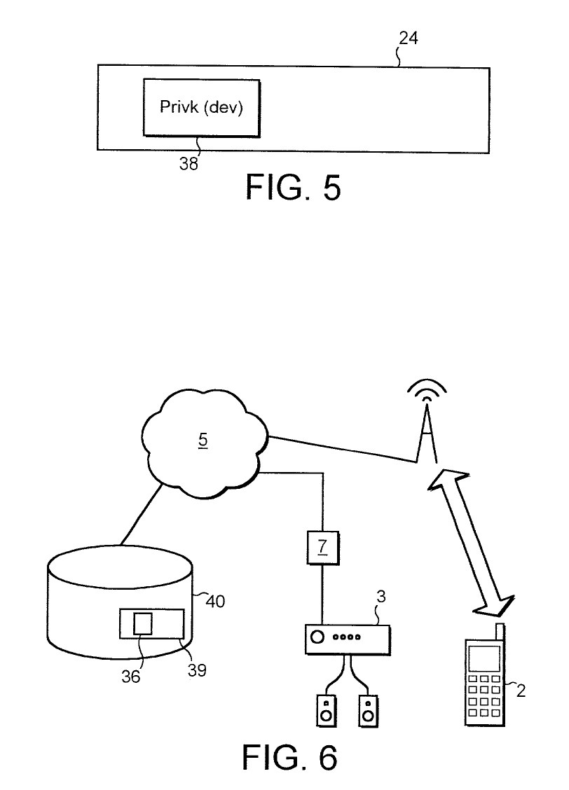

With particular reference to FIGS. 4 and 5, it will be appreciated by those skilled in the art that in order to decrypt such content it is necessary to have knowledge of the media private key PrivK(m) 37. Accordingly, the content owner may decide, possibly in return for a fee or other consideration, to distribute the media private key 37 to an authorized user utilizing a file format or other software object known as a voucher 36. The voucher 36 provides protection against unauthorized knowledge of the media private key PrivK(m) 37 by encrypting the key PrivK(m) 37 using a public key of the authorized user.

As those skilled in the art will appreciate, the Private Key PrivK(dev) 38 necessary to decrypt the particular content is available only to the authorized user such that within the PPE 22 the Private Key 38 is used to decrypt the private media key PrivK(m) 37 stored in the voucher 36. To safeguard the media private key 38, following decryption, it is placed within the tamper resistant SE 23 of the PTD 2. The voucher 36 may further include a set of license conditions which may restrict or otherwise influence the actions available to the authorized user in relation to the content. Such conditions are intended to be resolved by the protected processing environment following decryption of the license portion 41 of the voucher 36.

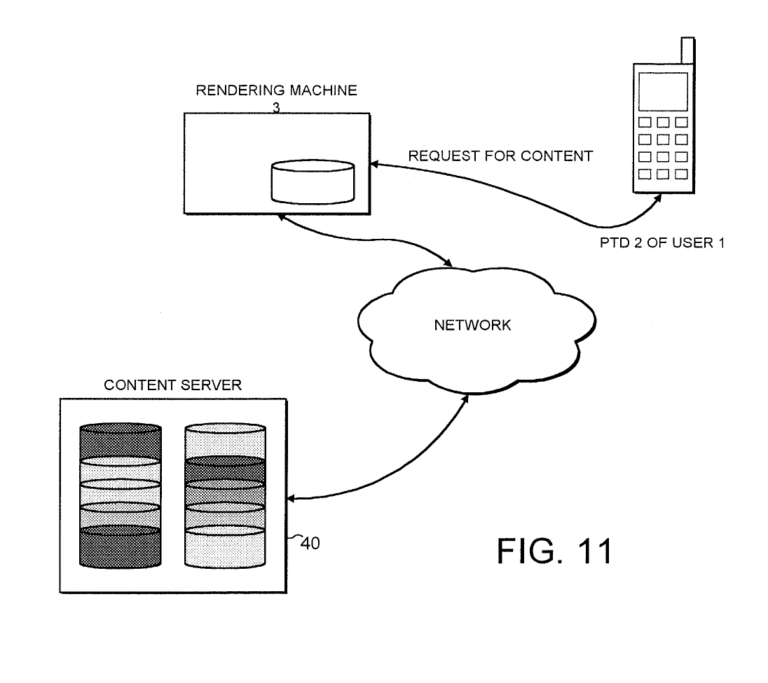

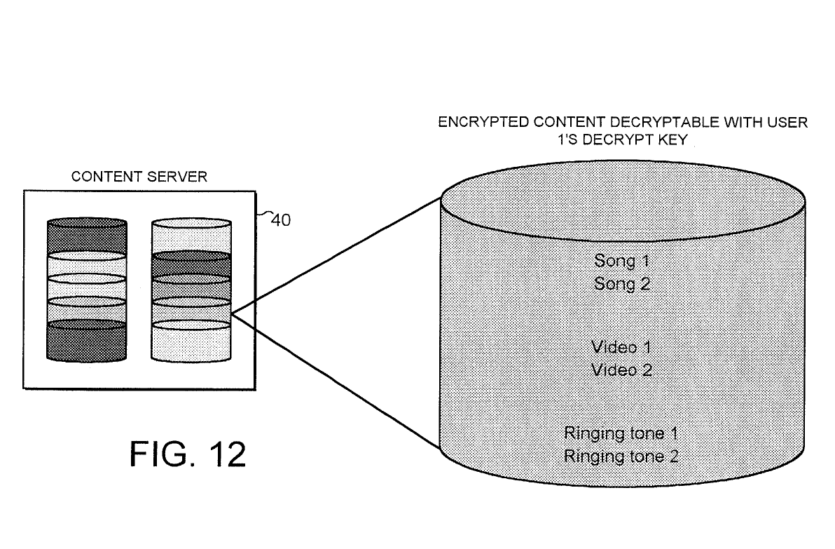

Turning to FIGS. 6 and 11, FIG. 6 in particular illustrates a possible storage location for a voucher 36. The voucher 36 is placed within a so-called wallet 39 on a storage device or mediary 40 connected to the network 5. The wallet 39 provides a secure store for a user's vouchers. The mediary 40 provides storage for a plurality of wallets each of which is associated with a particular user and each wallet may contain a number of different vouchers relating to different content. FIG. 12 is an illustration of content which could be available to a user on the mediary or server 40. Access to a particular wallet 39 is provided to the appropriate user following an authentication process carried out between the mediary 40 and a PTD PPE 22 having the requisite rights. Once access has been obtained to the wallet 39, the voucher 36 may be transmitted over an insecure channel. The voucher 36 is received by the user's PTD 2 and decrypted within the protected processing environment 22 of her PTD to 2 give the environment access to the media private key 37 for the purpose, already described, of decrypting the corresponding content.

As an alternative to remote storage of the voucher 36, it may be held within the general memory 12 of the PTD 2 until such time as it is required by the PPE 22 to enable access to the content. Storage within the general memory 12 may be preferred for frequently used vouchers 36 whilst remote storage in the mediary 40 may be utilized for vouchers 36 corresponding to less frequently accessed content. The determination of whether a voucher 36 should be stored locally in the general memory 12 or remotely in a wallet 39 on the mediary 40 may be determined by the user utilizing the UI and/or on the basis of frequency of access.

In one embodiment, the rendering machine 3 provides a decryption facility whereby content received by the rendering machine 3 is decrypted within its own PPE 29 using an appropriate media private key 37 obtained from a voucher 36 corresponding to that content. Accordingly, the media private key 37 contained in that voucher 36 must be securely transferred to the PPE 29 of the rendering device 3. As has already been mentioned, the media private key 37 is stored on a voucher 36 having been encrypted using an authorized user's public key. Thus, for the PPE 29 of the rendering machine 3 to be able to utilize the media private key 37 it must be decrypted which requires the use of the authorized user's private key 38. Clearly, the authorized user's private key 38 should not be revealed to a third party PPE 29 and hence must not leave the PPE 22 of the authorized users PTD 2. Thus, it is a requirement that the media private key 37 be decrypted within the PPE 22 of the PTD 2. A number of scenarios exist for carrying out this process which vary depending on the location of the voucher 36 and whether a direct or indirect connection exists between the PTD 2 and the rendering machine 3 to which the authorized user has directed a request to render the content.

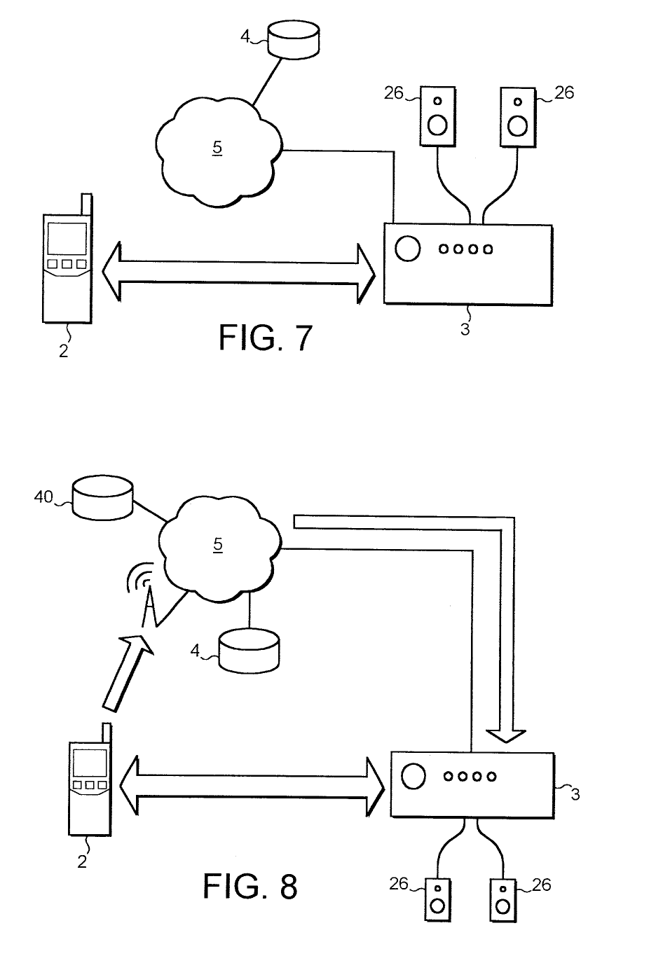

In a first scenario shown in FIG. 7, a direct connection is to be established between the PTD 2 and rendering machine 3, the voucher 36 being held on the PTD 2. Thus, the PTD 2 contacts the rendering machine 3 using Infrared, LPRF or a direct, cabled connection. A channel is negotiated between the PTD 2 and rendering machine 3 during which each is authenticated to the other. The PTD 2 indicates to the rendering machine 3 the content to be rendered, in this case played on a set of speakers 26 through an amplifier 25.

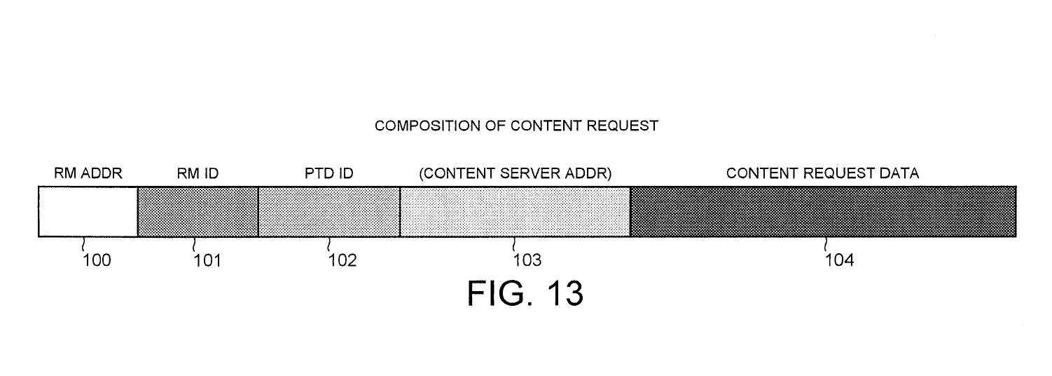

FIG. 13 illustrates the format of a content request which includes an indication of a rendering machine address 100, a rendering machine ID 101, a PTD ID 102, optionally a content server address 103, and content request data 104. The delivery of the requisite voucher 36 is made from a local storage location 12. The voucher 36 is received by the rendering machine PPE 29 and the content to which it relates is identified from reference held thereon. The rendering device 3 then determines whether the corresponding content is held in its own local storage 35. If not, the rendering machine seeks to download the content over the network interface 28 via a connection over the networks to a remote store, whereupon the downloaded content is placed into the local storage 35. Contemporaneously, the rendering machine PPE 29 requests the PTD 2 to supply the media private key 37 necessary to unlock or decrypt the content. The PTD 2 receives the request which contains the rendering machine public key certificate from the PTD interface 32 33 of the rendering machine 3 and proceeds to authenticate the certificate before decrypting the media private key of the voucher within the PTD PPE 22. Assuming the rendering machine public key is trusted, the PPE 22 then uses this public key to encrypt the media private key 37 which is then transferred, in its encrypted form, to the rendering machine PPE 2a via a direct connection interface 18,19. Whereupon, the rendering machine PPE 2a is able, using its corresponding private key to decrypt the media private key 37. Once in possession of the private key 37, the rendering machine PPE 29 is able to decrypt the content and deliver it to the rendering application 25, in this case the audio amplifier 25 which supplies the set of speakers 26. Where conditions are attached to the rendering of the content, these are placed in a license portion 41 of the voucher 36 with which conditions, in order to be trusted, the rendering machine PPE 2a is required to abide.

In a second scenario shown in FIG. 8, a direct connection is to be established between the PTD 2 and rendering machine 3, the voucher 36 being held within a wallet 39 on a Mediary 40. Thus, the PTD 2 contacts the rendering machine 3 using Infrared, LPRF or a direct, cabled connection 18,19. A channel is negotiated between the PTD 2 and rendering machine 3 during which each is authenticated to the other. The PTD 2 indicates to the rendering machine 3 the content to be rendered, in this case played on a set of speakers 26 through an amplifier 25. This requires the delivery of the requisite voucher 36 from a wallet 39 held on the remote repository 40 following the necessary authentication steps between the PTD 2 and repository 40 described previously. The voucher 36 is received by the rendering machine PPE 29 more over the network interface 28. This delivery route requires that the PTD PPE 22 provides the mediary 40 holding the wallet 39 with the IP address of the rendering machine 3 to which the voucher 36 should be delivered. The IP address is obtained from the rendering machine 3 during the authentication process described above. Following receipt of the voucher 36 by the rendering machine PPE 29, the content to which the voucher 36 relates is identified from reference held thereon. The rendering device 3 then determines whether the corresponding content is held in its own local storage 35. If not, the rendering machine 3 seeks to download the content over the network interface 28 via a connection to a remote store 4, whereupon the downloaded content is placed into the local storage 35. Contemporaneously, the rendering machine PPE 29 requests the PTD 2 to supply the media private key 37 necessary to unlock or decrypt the content. The PTD 2 receives the request which contains the rendering machine public key certificate from the PTD interface 32, 33 of the rendering machine 3 and proceeds to authenticate the certificate before decrypting the media private key of the voucher 36 within the PTD PPE 22. Assuming the rendering machine public key is trusted, the PPE 22 then uses this public key to encrypt the media private key which is then transferred, in its encrypted form to the rendering machine PPE 29 via a suitable interface 18,19. Whereupon, the rendering machine PPE 29 is able, using its corresponding private key to decrypt the media private key 37. Once in possession of the private key 37, the rendering machine PPE 29 is able to decrypt the content and deliver it to the rendering application, in this case the audio amplifier 25 which supplies the set of speakers 26. Where conditions are attached to the rendering of the content, these are placed in a license portion 41 of the voucher 36 with which conditions, in order to be trusted, the rendering machine PPE 29 is required to abide.

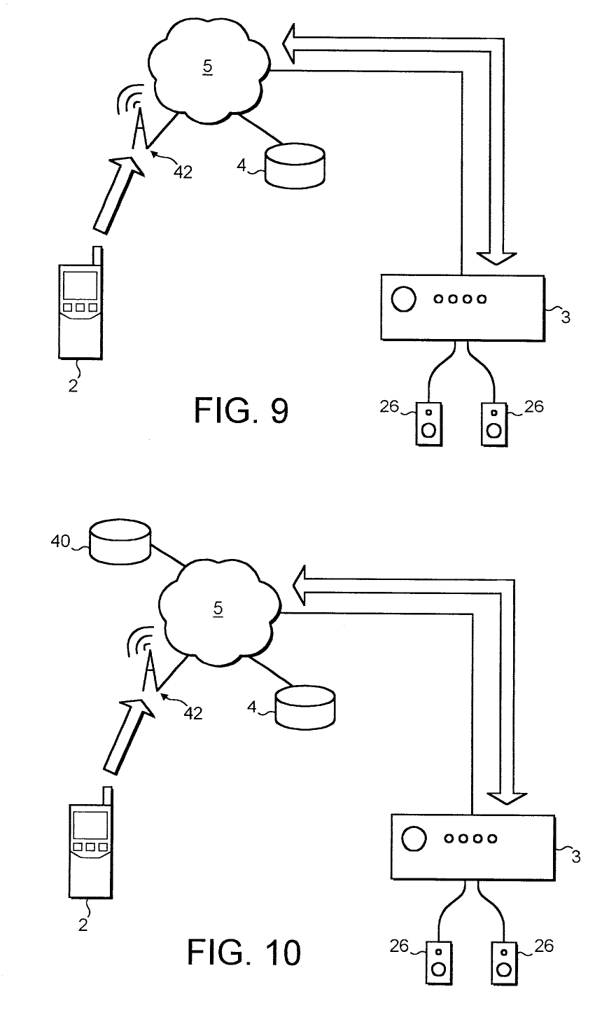

In a third scenario shown in FIG. 9, an indirect connection is to be established between the PTD 2 and rendering machine 3, the voucher 36 being held on the PTD 2. Thus, the PTD 2 connects to a network interworking unit or gateway 42 on the cellular network. Via the gateway 42, the PTD 2 contacts the rendering machine 3 using a corresponding IP address entered by the user of the PTD 2. A channel is then negotiated between the PTD 2 and rendering machine 3 during which each is authenticated to the other. The PTD 2 indicates to the rendering machine 3 the content to be rendered, in this case played through a set of speakers 26 an amplifier 25. This requires the delivery of the requisite voucher 37 from a local storage location 12. The voucher 36 is received by the rendering machine PPE 29 and the content to which it relates is identified from reference held thereon. The rendering device 3 then determines whether the corresponding content is held in its own local storage 35. If not, the rendering machine 3 seeks to download the content over the network interface 28 via a connection to a remote store 4, whereupon the downloaded content is placed into the local storage 35. Contemporaneously, the rendering machine PPE 29 requests the PTD 2 to supply the media private key 37 necessary to unlock or decrypt the content. The PTD 2 receives the request which contains the rendering machine public key certificate via the gateway 42 and proceeds to authenticate the certificate before decrypting the media private key of the voucher 36 within the PTD PPE 22. Assuming the rendering machine public key is trusted, the PPE then uses this public key to encrypt the media private key 37 which is then transferred, in its encrypted form to the rendering machine PPE 29. Whereupon, the rendering machine PPE 29 is able, using its corresponding private key to decrypt the media private key 37. Once in possession of the private key 37, the rendering machine PPE 29 is able to decrypt the content and deliver it to the rendering application, in this case the audio amplifier 25 which supplies the set of speakers 26. Where conditions are attached to the rendering of the content, these are placed in a license portion 41 of the voucher 36 with which conditions, in order to be trusted, the rendering machine PPE 29 is required to abide.

In a fourth scenario shown in FIG. 10, an indirect connection is to be established between the PTD 2 and rendering machine 3, the voucher 36 being held within a wallet on the mediary 40. The PTD 2 obtains a copy of the voucher 35 relating to the content which is to be rendered. As has previously been described, this is achieved by contacting the mediary 40 holding the wallet 39 of the user and extracting the relevant voucher 36. This voucher 36 is then stored locally 12 on the PTD. The PTD 2 then connects to a network interworking unit or gateway 42 on the cellular network 5. Via the gateway 42, the PTD 2 contacts the rendering machine 3 using a corresponding IP address entered by the user of the PTD 2. A channel is then negotiated between the PTD 2 and rendering machine 3 during which each is authenticated to the other. The PTD 2 indicates to the rendering machine 3 the content to be rendered, in this case played through a set of speakers 26 via an amplifier 25. This requires the delivery of the requisite voucher 36 from the local storage of the PTD 12 over the previously established channel to the rendering machine PPE 29. The voucher 36 is received by the rendering machine PPE 29 and the content to which it relates is identified from reference held thereon. The rendering machine 3 then determines whether the corresponding content is held in its own local storage 35. If not, the rendering machine 3 seeks to download the content over the network interface 28 via a connection to a remote store 4, whereupon the downloaded content is placed into the local storage 35. Contemporaneously, the rendering machine PPE 29 requests the PTD 2 to supply the media private key 37 necessary to unlock or decrypt the content. The PTD 2 receives the request which contains the rendering machine public key certificate via the gateway 42 and proceeds to authenticate the certificate before decrypting the media private key 37 of the voucher within the PTD PPE 22. Assuming the rendering machine public key is trusted, the PPE 2 then uses this public key to encrypt the media private key 37 which is then transferred, in its encrypted form to the rendering machine PPE 29. Whereupon, the rendering machine PPE 29 is able, using its corresponding private key to decrypt the media private key 37. Once in possession of the private key 37, the rendering machine PPE 29 is able to decrypt the content and deliver it to the rendering application 25, in this case the audio amplifier which supplies the set of speakers 26. Where conditions are attached to the rendering of the content, these are placed in a license portion 41 of the voucher 36 with which conditions, in order to be trusted, the rendering machine PPE 29 is required to abide.

Turning now to another embodiment the PPE 22 of the PTD 2 is used to carry out the decryption of content for rendering by the rendering machine 3. Such an embodiment requires the existence of a secure channel between the PTD 2 and rendering machine 3 over which the decrypted content is deliverable. Depending on the location of a particular voucher 36 relating to that content and the nature of the connection between the PTD 2 and rendering machine 3, a number of different scenarios exist, some of which are set out below. In each scenario, it is the case that the PTD 2 and rendering machine 3 must each be assured of the others trustworthiness before the transfer of any content.

In a first scenario, a direct connection is to be established between the PTD 2 and rendering machine 3, the voucher 36 being held on the PTD 2. Thus, the PTD 2 contacts the rendering machine 3 using Infrared, LPRF or a direct, cabled connection 18, 19. A secure channel is negotiated between the PTD 2 and rendering machine 3 during which each is authenticated to the other and Transaction Level Security (TLS) or a suitable alternative is established. The PTD 2 indicates to the rendering machine 3 the content to be rendered, in this case an audio recording for playback via an amplifier 25 connected to a pair of speakers 26. The PTD PPE 22 extracts the address of the content from the voucher 36 and passes it over the secure channel to the rendering machine 3. Subsequently, the rendering machine 3 determines whether the corresponding content is held in its own local storage 35. If not, the rendering machine 3 seeks to download the content over the network interface 28 via a connection to a remote store 4, whereupon the downloaded content is placed into the local storage 35. Contemporaneously, PTD PPE 22 proceeds to decrypt the media private key 37 of the voucher and stores this key in the PTD SE 23. Once at this stage, the PTD 2 indicates to the rendering machine 3 its readiness to decrypt the content. Accordingly, rendering machine 3 delivers the content from the local storage 35 over the secure interface to the PTD PPE 22. The PTD PPE 22 decrypts the content as it is received and returns the decrypted content as a datastream to the rendering machine 3. The rendering machine 3 receives the datastream and renders the content via the amplifier 25 and speakers 26. Where conditions are attached to the rendering of the content, these are placed in a license portion 41 of the voucher 38 with which conditions, in order to be trusted, the PTD PPE 22 is required to abide.

In a second, similar scenario, the voucher 36 is found not on the PTD 2 but within a wallet 39 held by a mediary 40. Accordingly, the PTD 2 must first obtain access to the voucher 36 and this is carried out as has been previously stated by an authentication process between the PTD 2 and mediary 40. Subsequently, the voucher 36 is delivered to the general memory 12 of the PTD 2 prior to decryption of the media private key 37 within the PPE 22 and the subsequent process set out above in relation to the first scenario.

In a third scenario, the PTD 2 is indirectly connected to the rendering machine 3 in the same manner as described in the third scenario in relation to the previous embodiment with the voucher 37 being held on the PTD 2. Clearly, the channel used for the indirect connection must have sufficient bandwidth to permit the transfer of data securely between the PTD 2 and rendering machine 3 if real or near-real time rendering of content is to be performed by the rendering machine 3. Alternatively, where bandwidth constraints dictate, the decrypted content may be delivered to a secure buffer within the rendering machine 3 and rendered off-line.

As before in relation to the fourth scenario of the previous embodiment, in a further scenario, the PTD 2 is indirectly connected to the rendering machine 3. However, the voucher 36 is initially held within a wallet 37 on the mediary 40. As a result, the PTD 2 must first carry out the necessary authentication steps to gain access to the voucher 36 which may then be used as detailed in the previous scenarios to decrypt content received from the rendering machine 3 and to return it to the rendering machine 3 relying on the security of the channel for protection of the content.

It will be appreciated by those skilled in the art that the above embodiments and corresponding scenarios are intended to be merely illustrative of the invention. In particular, the public key infrastructure (PKI) which provides security for the content may be replaced with a symmetric key technology. It will also be recognized that rendering of content may be carried out on any suitable machine such as a television, video recorder, electronic book or the like.

What is claimed is:

1. A method of rendering content on a rendering machine connectable to a personal trusted device, said method comprising the steps of:
receiving in the rendering machine a request from a personal trusted device connected thereto, said request identifying encrypted content to be rendered;
obtaining said encrypted content from a repository; and
acquiring a content decryption key from said personal trusted device, said key being used to decrypt said content.

2. A method according to claim 1, wherein said content decryption key is encrypted using a public key associated with said personal trusted device.

3. A method according to claim 2, wherein said encrypted content decryption key is retrieved from a repository.

4. A method according to claim 3, wherein said rendering machine delivers said encrypted content decryption key to said personal trusted device.

5. A method according to claim 4, wherein said rendering machine acquires said content decryption key, said key having been encrypted using a public key associated with said rendering machine.

6. A method according to claim 5, wherein said rendering machine decrypts said content decryption key using a corresponding private key.

7. A computer program for rendering content on a rendering machine connectable to a personal trusted device, said computer program when executed causes the rendering machine to perform the steps of:
receiving in the rendering machine a request from a personal trusted device connected thereto, said request identifying encrypted content to be rendered;
obtaining said encrypted content from a repository; and
acquiring a content decryption key from said personal trusted device, said key being used to decrypt said content.

8. A method of rendering content on a rendering machine connectable to a personal trusted device, said method comprising the steps of:
sending from the personal trusted device a request identifying encrypted content to be rendered to said rendering machine; and
responding to a request from said rendering machine by delivering a content decryption key corresponding to the encrypted content obtained thereby.

9. A method according to claim 8, wherein said content decryption key is encrypted using a public key associated with said personal trusted device.

10. A method according to claim 8, wherein said encrypted content decryption key is retrieved from a repository.

11. A method according to claim 10, wherein said rendering machine receives said encrypted content decryption key from said personal trusted device.

12. A method according to claim 11, wherein said personal trusted device delivers said content decryption key to said rendering machine, said key having been encrypted by said personal trusted device using a public key associated with said rendering machine.

13. A method according to claim 12, wherein said rendering machine decrypts said content decryption key using a corresponding private key.

14. A computer program for rendering content on a rendering machine connectable to a personal trusted device, said computer program when executed causes the rendering machine to perform the steps of:
sending from the personal trusted device a request identifying encrypted content to be rendered to said rendering machine; and
responding to a request from said rendering machine by delivering a content decryption key corresponding to the encrypted content obtained thereby.

15. A method of rendering content on a rendering machine connectable to a personal trusted device, said method comprising the steps of:
receiving in the rendering machine a request from a personal trusted device connected thereto said request identifying encrypted content to be rendered;
obtaining said encrypted content from a repository;
delivering said content to the personal trusted device; and
establishing a secure channel with said personal trusted device in order to receive decrypted content therefrom.

16. A method according to claim 15, wherein said rendering machine delivers an encrypted content decryption key to said personal trusted device.

17. A computer program for rendering content on a rendering machine connectable to a personal trusted device, said computer program when executed causes the rendering machine to perform the steps of:
receiving in the rendering machine a request from a personal trusted device connected thereto said request identifying encrypted content to be rendered;
obtaining said encrypted content from a repository;
delivering said content to the personal trusted device; and
establishing a secure channel with said personal trusted device in order to receive decrypted content therefrom.

18. A method of rendering content on a rendering machine connectable to a personal trusted device, said method comprising the steps of:
sending from the personal trusted device a request identifying encrypted content to be rendered to said rendering machine;
receiving said encrypted content from said rendering machine;
establishing a secure channel with said rendering machine; and
decrypting said encrypted content before returning said decrypted content over said channel to said rendering machine.

19. A method according to claim 18, wherein a content decryption key is used to decrypt said encrypted content, said key being encrypted using a public key associated with said personal trusted device.

20. A method according to claim 19, wherein said encrypted content decryption key is retrieved from a repository.

21. A method according to claim 20, wherein said rendering machine delivers said encrypted content decryption key to said personal trusted device.

22. A computer program for rendering content on a rendering machine connectable to a personal trusted device, said computer program when executed causes the rendering machine to perform the steps of:
sending from the personal trusted device a request identifying encrypted content to be rendered to said rendering machine;
receiving said encrypted content from said rendering machine;
establishing a secure channel with said rendering machine; and
decrypting said encrypted content before returning said decrypted content over said channel to said rendering machine.

23. A rendering machine for rendering content comprising:
a communication interface operable to establish a channel with a personal trusted device and in response to a request from a personal trusted device, to download encrypted content identified in said request; and
a decryption engine operable to decrypt said content using a content decryption key obtained from said personal trusted device.

24. A machine as claimed in claim 23, wherein said encrypted content decryption key is retrieved from a repository.

25. A machine as claimed in claim 24, wherein said rendering machine acquires said content decryption key, said key having been encrypted using a public key associated with said rendering machine.

26. A machine as claimed in claim 25, wherein said decryption engine is operable to decrypt said content decryption key using a corresponding private key.

27. A personal trusted device for connection to a rendering machine, comprising:
a user interface for selecting encrypted content to be rendered;
a communications terminal operable to establish a channel with a rendering machine over which a request identifying said encrypted content may be delivered; and
a protected processing environment operable to provide a content decryption key corresponding to content selected by said user interface,
wherein said key is deliverable over said channel to facilitate decryption of said content obtained by said rendering machine.

28. A device as claimed in claim 27, wherein said terminal is operable to retrieve said encrypted content decryption key from a repository.

29. A device as claimed in claim 27, wherein said terminal is operable to receive said encrypted content decryption key from said rendering machine.

30. A personal trusted device for connection to a rendering machine, comprising:
a user interface for selecting encrypted content to be rendered;
a communications terminal operable to establish a secure channel with a rendering machine over which a request identifying said encrypted content may be delivered and over which corresponding encrypted content is returned; and
a protected processing environment operable to provide a content decryption key corresponding to content selected by said user interface wherein said content decryption key being utilized to decrypt said content returned by said rendering machine, and
wherein said decrypted content being delivered over said secure channel to said rendering machine.

31. A device as claimed in claim 30, wherein said terminal is operable to retrieve said encrypted content decryption key from a repository.

32. A device as claimed in claim 30, wherein said terminal is operable to receive said encrypted content decryption key from said rendering machine.

33. A rendering method for encrypted content comprising the steps of:
generating a content rendering request on a personal trusted device, transmitting said request identifying the encrypted content to a remote rendering machine; and
providing a corresponding decryption key to said machine to facilitate decryption of said content prior to rendering thereof.

34. A rendering method for encrypted content comprising the steps of:
receiving a request from a personal trusted device identifying encrypted content;
sourcing said identified content; and
obtaining a decryption key corresponding to said content whereby said content may be decrypted and rendered.
